(19) United States
(12) Patent Application Publication
(10) Pub. No.: US 2014/0063788 A1
(43) Pub. Date: Mar. 6, 2014

(54) Backlight System and Liquid Crystal Devices with the Same

(71) Applicants: Yi-cheng Kuo, Shenzhen (CN); Yu-chun Hsiao, Shenzhen (CN); Chengwen Que, Shenzhen (CN); Pangling Zhang, Shenzhen (CN); Dehua Li, Shenzhen (CN)

(72) Inventors: Yi-cheng Kuo, Shenzhen (CN); Yu-chun Hsiao, Shenzhen (CN); Chengwen Que, Shenzhen (CN); Pangling Zhang, Shenzhen (CN); Dehua Li, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/641,414

(22) PCT Filed: Sep. 3, 2012
(86) PCT No.: PCT/CN2012/080914

§ 371 Date: Oct. 15, 2012

(30) Foreign Application Priority Data
Aug. 31, 2012 (CN) 201210316780.1

(51) Int. Cl. G09F 13/04

(52) U.S. Cl. CPC G09F 13/0413
USPC 362/97.2

(57) ABSTRACT

A backlight system and the liquid crystal device are disclosed. The backlight system includes a back plate, optical films and a protecting member. The back plate includes at least two main connecting members, and at least one main connecting member includes a top plate and a down plate. The protecting member includes a first portion and a second portion. The protecting member is fixed on the top plate so that the first portion is arranged above the top plate to separate the top plate and the liquid crystal panel above the top plate. The second portion is arranged on a down surface of the top plate to separate the top plate and the optical films. In this way, the assembling efficiency is high and the labor cost is low. In addition, the risk of scratching the liquid crystal panels and the optical films during the assembling process of the backlight system is also reduced.

### BACKGROUND OF THE INVENTION

1. Field of the Invention

Embodiments of the present disclosure relate to display technology, and more particularly to a backlight system and the liquid crystal device with the same.

2. Discussion of the Related Art

Liquid crystal devices include back plates, reflective sheets, optical films, plastic frames, display panels and front frames. Currently, integrally formed back plates are assembled with liquid crystal display modules by manual processes. The assembly processes of the backlight system of the liquid crystal display module includes disposing the integrally formed back plate flatly, fixing the reflective sheet on the back plate, and assembling the reflective sheet and the optical film with the back plate in turn. The remaining steps include disposing the plastic frame, disposing the display panel on the plastic frame, disposing the front frame, and assembling the front frame and the back plate. It is obvious that a lot of manual processes and assembling time are needed to complete the above assembly processes of liquid crystal display module.

In addition, there are different sizes of the display panels for fulfilling consumer's demands. For example, the sizes of the display panels may be 31.5, 42, 46, 48, or 55 inches. Accordingly, different back plates are needed to be engaged with the display panels. Also, the back plates with larger size are difficult to be transported.

Furthermore, the temperature of one side of the back plate with light sources is higher due to the heat generated from the light sources. While the back plates are generally made by metallic materials with low thermal insulation, the above-mentioned side of the back plate thus may have light leakage problem due to the high temperature.

### SUMMARY

In order to resolve the technical issue encountered by the prior art, the claimed invention introduces a backlight system and the liquid crystal device with high assembling efficiency, low labor cost, and low risk of scratching the liquid crystal panels during the assembling process of the backlight system.

In one aspect, the backlight system includes a back plate, optical films and a protecting member. The back plate includes a first connecting member, a second connecting member, a third connecting member, and a fourth connecting member. Wherein the first connecting member, the second connecting member, the third connecting member, and the fourth connecting member are substantially bar-shaped. Front ends and rear ends of the connecting members are connected to form the surrounding back plate. At least one connecting members includes a down plate, a side plate extending upward from the down plate, and a top plate extending inward from a top of the side plate and through holes on the top plate. Edges of the optical films are embedded in the space between the top plate and the down plate. The protecting member includes a first portion, a second portion, a third portion, fixing pillars. The third portion connects the first portion and the second portion to form a slot with a U-shaped cross section, the fixing pillars are fixed on a first surface of the first portion. The first surface faces toward the second portion. At least portions of the top plate is embedded to the slot and the fixing pillars are inserted into the through holes so as to fix the protecting member on the connecting members. The third portion is arranged corresponding to the top plate. The first portion is arranged above the top plate to separate the top plate and the liquid crystal panel above the top plate, and the second portion is arranged on a down surface of the top plate to separate the top plate and the optical films below the top plate so as to protect the liquid crystal panel and the optical films.

Wherein the top plate includes two through holes and the protecting member includes two fixing pillars.

Wherein light sources are arranged in a space between the down plate and the top plate, and the top plate of the back plate includes a first thermo insulating attribute. The first portion of the protecting member includes a second thermo insulating attribute.

Wherein the connecting members are made by metallic materials and the protecting member are made by rubber materials.

Wherein the connecting member includes at least two connected auxiliary connecting members.

In another aspect, the backlight system includes a back plate, optical films and a protecting member. The back plate includes at least two main connecting members, and front ends and rear ends of the main connecting members are connected to form the back plate. At least one main connecting member includes a down plate, a side plate extending upward from the down plate, and a top plate extending inward from a top of the side plate. Edges of the optical films are embedded in a space between the top plate and the down plate. The protecting member is fixed on the top plate. The protecting member includes a first portion arranged above the top plate to separate the top plate and the liquid crystal panel above the top plate, and a second portion arranged on a down surface of the top plate to separate the top plate and the optical films below the top plate so as to protect the liquid crystal panel and the optical films.

Wherein the protecting member includes a third portion connecting the first portion and the second portion to form a slot with U-shaped cross section, portions of the top plate is embedded to the slot, and the third portion is arranged corresponding to the top plate of the back plate; the protecting member includes fixing pillars fixed on a first surface of the first portion; and through holes are arranged on the top plate of the back plate corresponding to a location of the fixing pillars so that the protecting member is fixed on the main connecting member by inserting the fixing pillars into the through holes.

Wherein the protecting member includes two fixing pillars.

Wherein light sources are arranged in a space between the down plate and the top plate, and the top plate of the back plate includes a first thermo insulating attribute; and the first portion of the protecting member includes a second thermo insulating attribute.

Wherein the main connecting members are made by metallic materials and the protecting member are made by rubber materials.

Wherein the main connecting members are assembled by latches, screws, weld, or glue.

Wherein the connecting member includes at least two connected auxiliary connecting members.

Wherein the main connecting members includes a first connecting member, a second connecting member, a third connecting member, and a fourth connecting member; and the first connecting member, the second connecting member, the third connecting member, and the fourth connecting member are substantially bar-shaped, front ends and rear ends of the connecting members are connected to form the surrounding back plate.

In another aspect, a liquid crystal device includes a backlight system and a liquid crystal panel. The backlight system includes a back plate, optical films and a protecting member. The back plate includes at least two main connecting members. Front ends and rear ends of the main connecting members are connected to form the back plate. At least one main connecting members includes a down plate, a side plate extending upward from the down plate, a top plate extending inward from a top of the side plate, edges of the optical films are embedded in a space between the top plate and the down plate. The protecting member is fixed on the top plate. The protecting member includes a first portion arranged above the top plate to separate the top plate and the liquid crystal panel above the top plate, and a second portion arranged on a bottom surface of the top plate to separate the top plate and the optical films below the top plate so as to protect the liquid crystal panel and the optical films.

Wherein the protecting member includes a third portion connecting the first portion and the second portion to form a slot with U-shaped cross section, portions of the top plate is embedded to the slot, and the third portion is arranged corresponding to the top plate; the protecting member includes fixing pillars fixed on a first surface of the first portion; and through holes are arranged on the top plate of the back plate corresponding to a location of the fixing pillars so that the protecting member is fixed on the main connecting member by inserting the fixing pillars into the through holes.

### BRIEF DESCRIPTION OF THE DRAWINGS

FIG. 1 is a partial sectional view of the backlight system of one embodiment.

FIG. 2 is an exploded isometric view of the back plate of the backlight system of one embodiment.

FIG. 3 is an exploded view of one main connecting member of the back plate of one embodiment.

FIG. 4 is a schematic view of the main connecting member of FIG. 3 in the assembling process.

FIG. 5 is an exploded view of another main connecting member of the back plate of one embodiment.

FIG. 6 is a schematic view of the main connecting member of FIG. 5 in the assembling process.

FIG. 7 is an isometric view showing structure of the protecting member of the backlight system of one embodiment.

FIG. 8 is a partial isometric view showing the protecting member being fixed on the connecting member of the back plate of one embodiment.

FIG. 9 is a partial exploded view showing the protecting member and the connecting member of the back plate of one embodiment.

### DETAILED DESCRIPTION OF THE EMBODIMENTS

Embodiments of the invention will now be described more fully hereinafter with reference to the accompanying drawings, in which embodiments of the invention are shown.

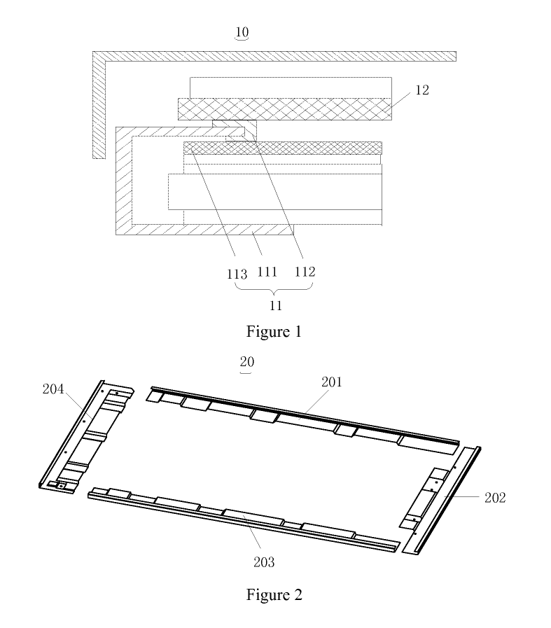

FIG. 1 is a partial sectional view of the backlight system of one embodiment. As shown, a backlight system 11 of a liquid display device 10 includes a back plate 111, a protecting member 112, and an optical film 113. The back plate 111 includes at least two main connecting members, and front ends and rear ends of the main connecting members are connected to form the back plate 111.

The main connecting members may be assembled by latches, screws, weld, or glue. As shown in FIG. 2, the backlight system 20 may include four main connecting members. In one embodiment, the main connecting members include a first connecting member 201, a second connecting member 202, a third connecting member 203, and a fourth connecting member 204. The four main connecting members are substantially bar-shaped, and front ends and rear ends of the main connecting member are connected to form a surrounding back plate 20.

The main connecting member further includes at least two auxiliary connecting members. The two auxiliary connecting members may be assembled by latches, screws, weld, or glue to form the main connecting member. The auxiliary connecting members may be adopted by the main connecting members with different sizes. Thus, the molds may be shared and the cost of the molds and products are reduced.

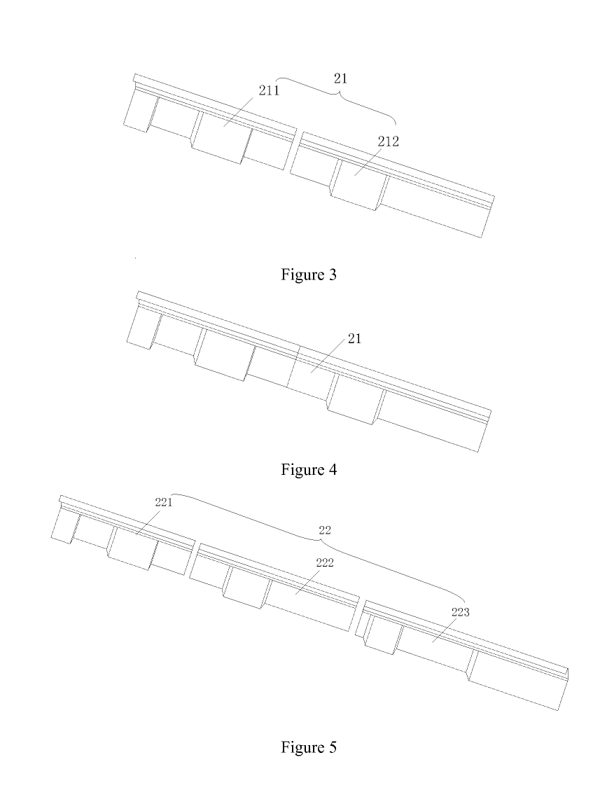

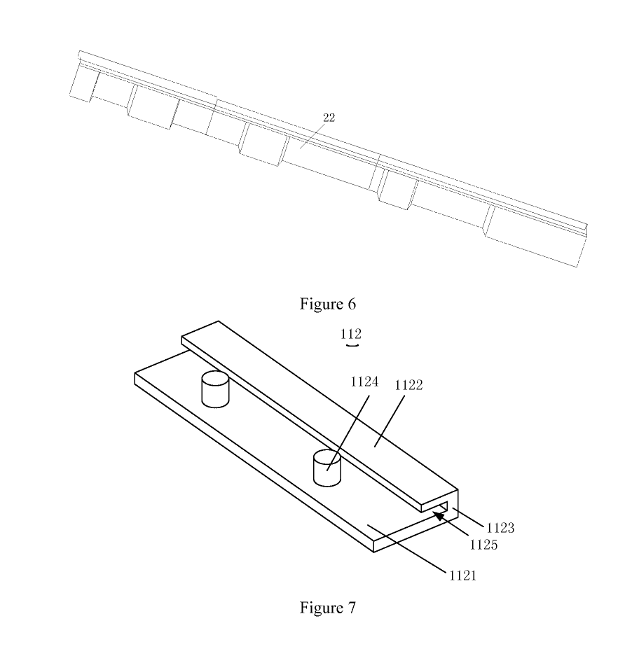

As shown in FIGS. 3, 4, 5 and 6, the main connecting member 21 includes a first auxiliary connecting member 211 and a connected second auxiliary connecting member 212. The main connecting member 22 includes a third auxiliary connecting member 221, a fourth auxiliary connecting member 222, and a fifth auxiliary connecting member 223. The third auxiliary connecting member 221, the fourth auxiliary connecting member 222, and the fifth auxiliary connecting member 223 are connected to form the main connecting member 22. The first auxiliary connecting member 211 is the same with the third auxiliary connecting member 221, and the second auxiliary connecting member 212 is the same with the fourth auxiliary connecting member 222. Thus, the first auxiliary connecting member 211 and the third auxiliary connecting member 221 may be manufactured by the same mold. In addition, the second auxiliary connecting member 212 and the fourth auxiliary connecting member 222 may be manufactured by the same mold.

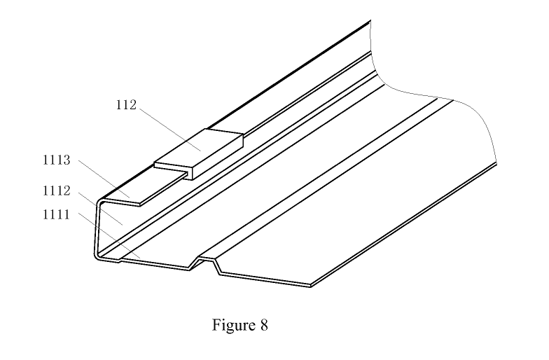

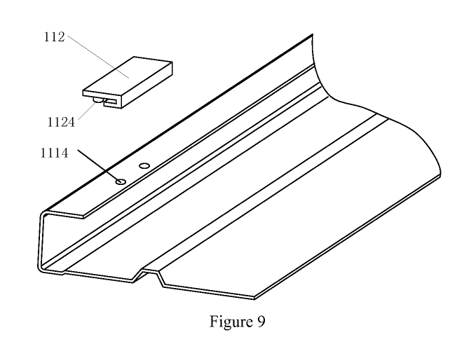

Referring to FIGS. 7, 8 and 9, at least one main connecting member of the back plate 111 includes a down plate 1111, a side plate 1112 extending upward from the down plate 1111, a top plate 1113 extending inward from a top of the side plate 1112, and through holes 1114 on the top plate 1113. The protecting member 112 includes a first portion 1121, a second portion 1122, a third portion 1123, and fixing pillars 1124. The third portion 1123 connects the first portion 1121 and the second portion 1122 to form a slot 1125 with a U-shaped cross-section.

The fixing pillars 1124 are fixed on a first surface of the first portion 1121, and the first surface faces toward the second portion 1122. The fixing pillars 1124 are inserted into the through holes 1114 of the back plate 111 along a top-down direction. At least a portion of the top plate 1113 of the back plate 111 is embedded to the slot 1125 of the protecting member 112 so that the protecting member 112 is fixed on the main connecting member of the back plate 111. In addition, the third portion 1123 is arranged corresponding to the top plate 1113 of the back plate 111. The protecting member 112 may include, but not limited to, two fixing pillars 1124. In other embodiments, the protecting member 112 may be assembled with the main connecting member without the fixing pillars 1124. For example, the main connecting member without the through holes and the protecting member 112 without the fixing pillars 1124 may be assembled by gluing the first surface of the first portion 1121 and a second surface of the second portion 1122 facing toward the first surface of the first portion 1121, and inserting the portions of the top plate 1113 of the back plate 111 to the slot 1125 of the protecting member 112. In this way, the first surface of the first portion 1121 contacts directly with a top surface of the top plate 1113, and the second surface of the second portion 1122 of the first portion 1121 contacts directly with a down surface of the top plate 1113 so that the protecting member 112 is fixed on the top plate 1113.

When the protecting member 112 is fixed on the top plate 1113, the first portion 1121 is arranged above the top plate 1113. The first portion 1121 contacts with a liquid crystal panel 12 on the top plate 1113 and the first portion 1121 separates the top plate 1113 and the liquid crystal panel 12. The second portion 1122 is arranged on the down surface of the top plate 1113, and the second portion 1122 contacts with the optical film 113 embedded in the space between the top plate 1113 and the down plate 1111. In this way, the top plate 1113 and the optical film 113 are spaced apart by the protecting member 112. Therefore, the main connecting members for assembling the back plate 111 with the liquid crystal panel 12 and the optical film 113 are capable of protecting the liquid crystal panel 12 and the optical film 113 from being damaged by the back plate 111.

Light sources (not shown) are arranged in a space between the down plate 1111 and the top plate 1113 of the back plate 111. In addition, the top plate 1113 of the back plate 111 has a first thermo insulating attribute, and the first portion 1121 of the protecting member 112 has a second thermo insulating attribute. The second thermo insulating attribute is better than the first thermo insulating attribute. As such, the heat generated by the light sources is prevented from being transmitted to edges of the liquid crystal panel 12 contacting with the top plate 1113. The temperature of the contacted portions of the liquid crystal panel 12 and the top plate 1113 is thus reduced so that the liquid crystal panel 12 may be prevented from light leakage. In the embodiment, the main connecting members may be made by metallic materials, and the protecting member 112 may be made by soft materials with high thermo insulating attributes, such as rubber.

In the embodiments, the backlight plate includes at least two main connecting members. The backlight plate is formed by connecting front and rear ends of one main connecting member. A reflective plate, a light guiding plate, the optical film and the liquid crystal panels may be assembled as one assembly, and the main connecting members are then fixed on edges of the above mentioned assembly so as to fasten the reflective plate, the light guiding plate and the optical film on its corresponding location. The above assembly method may be achieved by automation devices so as to enhance the assembly efficiency. In addition, the protection member includes a first portion and a second portion. The first portion is arranged above the top plate to separate the top plate and the liquid crystal panel. The second portion is arranged on the down surface of the top plate to separate the top plate and the optical films arranged below the top plate. In this way, the liquid crystal panel and the optical films have not contacted with the back plate directly, and thus are prevented from being damaged by the back plate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight system of a liquid crystal device, comprising:
the backlight system comprises a back plate, optical films and a protecting member;
the back plate comprises a first connecting member, a second connecting member, a third connecting member, and a fourth connecting member, wherein the first connecting member, the second connecting member, the third connecting member, and the fourth connecting member are substantially bar-shaped, front ends and rear ends of the connecting members are connected to form the surrounding back plate, and at least one connecting members comprises a down plate, a side plate extending upward from the down plate, and a top plate extending inward from a top of the side plate, and through holes on the top plate;
edges of the optical films are embedded in the space between the top plate and the down plate;
the protecting member comprises a first portion, a second portion, a third portion, fixing pillars, the third portion connects the first portion and the second portion to form a slot with a U-shaped cross section, the fixing pillars are fixed on a first surface of the first portion, the first surface faces toward the second portion;
at least portions of the top plate is embedded to the slot and the fixing pillars are inserted into the through holes so as to fix the protecting member on the connecting members, and the third portion is arranged corresponding to the top plate, the first portion is arranged above the top plate to separate the top plate and the liquid crystal panel above the top plate, the second portion is arranged on a down surface of the top plate to separate the top plate and the optical films below the top plate so as to protect the liquid crystal panel and the optical films.

2. The backlight system as claimed in claim 1, wherein the top plate comprises two through holes and the protecting member comprises two fixing pillars.

3. The backlight system as claimed in claim 1, wherein light sources are arranged in a space between the down plate and the top plate, and the top plate of the back plate comprises a first thermo insulating attribute; and
the first portion of the protecting member comprises a second thermo insulating attribute.

4. The backlight system as claimed in claim 3, wherein the connecting members are made by metallic materials, and the protecting members are made by rubber materials.

5. The backlight system as claimed in claim 1, wherein the connecting member comprises at least two connected auxiliary connecting members.

6. A backlight system of a liquid crystal device, comprising:
the backlight system comprises a back plate, optical films and a protecting member;
the back plate comprises at least two main connecting members, front ends and rear ends of the main connecting members are connected to form the back plate, and at least one main connecting members comprises a down plate, a side plate extending upward from the down plate, a top plate extending inward from a top of the side plate, edges of the optical films are embedded in a space between the top plate and the down plate; and
the protecting member is fixed on the top plate, the protecting member comprises a first portion arranged above the top plate to separate the top plate and the liquid crystal panel above the top plate, and a second portion arranged on a down surface of the top plate to separate the top plate and the optical films below the top plate so as to protect the liquid crystal panel and the optical films.

7. The backlight system as claimed in claim 6, wherein the protecting member comprises a third portion connecting the first portion and the second portion to form a slot with U-shaped cross section, portions of the top plate is embedded to the slot, and the third portion is arranged corresponding to the top plate of the back plate;
the protecting member comprises fixing pillars fixed on a first surface of the first portion; and
through holes are arranged on the top plate of the back plate corresponding to locations of the fixing pillars so that the protecting member is fixed on the main connecting member by inserting the fixing pillars into the through holes.

8. The backlight system as claimed in claim 6, wherein the protecting member comprises two fixing pillars.

9. The backlight system as claimed in claim 6, wherein light sources are arranged in a space between the down plate and the top plate, and the top plate of the back plate comprises a first thermo insulating attribute; and
the first portion of the protecting member comprises a second thermo insulating attribute.

10. The backlight system as claimed in claim 9, wherein the main connecting members are made by metallic materials, and the protecting members are made by rubber materials.

11. The backlight system as claimed in claim 6, wherein the main connecting members are assembled by latches, screws, weld, or glue.

12. The backlight system as claimed in claim 6, wherein the connecting member comprises at least two connected auxiliary connecting members.

13. The backlight system as claimed in claim 6, wherein the main connecting members comprises a first connecting member, a second connecting member, a third connecting member, and a fourth connecting member; and
the first connecting member, the second connecting member, the third connecting member, and the fourth connecting member are substantially bar-shaped, front ends and rear ends of the connecting members are connected to form the surrounding back plate.

14. A liquid crystal device, comprising:
a backlight system and a liquid crystal panel;
the backlight system comprises a back plate, optical films and a protecting member;
the back plate comprises at least two main connecting members, front ends and rear ends of the main connecting members are connected to form the back plate, and at least one main connecting members comprises a down plate, a side plate extending upward from the down plate, a top plate extending inward from a top of the side plate, edges of the optical films are embedded in a space between the top plate and the down plate; and
the protecting member is fixed on the top plate, the protecting member comprises a first portion arranged above the top plate to separate the top plate and the liquid crystal panel above the top plate, and a second portion arranged on a bottom surface of the top plate to separate the top plate and the optical films below the top plate so as to protect the liquid crystal panel and the optical films.

15. The liquid crystal device as claimed in claim 14, wherein
the protecting member comprises a third portion connecting the first portion and the second portion to form a slot with U-shaped cross section, portions of the top plate is embedded to the slot, and the third portion is arranged corresponding to the top plate of the back plate;
the protecting member comprises fixing pillars fixed on a first surface of the first portion; and
through holes are arranged on the top plate of the back plate corresponding to locations of the fixing pillars so that the protecting member is fixed on the main connecting member by inserting the fixing pillars into the through holes.
